(19) United States
(12) Patent Application Publication
(10) Pub. No.: US 2026/0305526 A1
(43) Pub. Date: Oct. 8, 2026

(54) MOWING PERFORMANCE OPTIMIZATION

(71) Applicant: Deere & Company, Moline, IL (US)

(72) Inventors: Mahesh Somarowthu, Pune (IN); DARIN L. ROTH, Mount Pleasant, IA (US); SCOTT D. CLAIR, Iowa City, IA (US); Faiz Khan, Pune (IN); PRANGYA P. SATAPATHY, Pune (IN)

(21) Appl. No.: 19/098,282

(22) Filed: Apr. 2, 2025

(51) Int. Cl. A01D 34/00; A01D 43/10

(52) U.S. Cl. CPC A01D 34/006; A01D 43/10

(57) ABSTRACT

A crop harvesting implement includes independent drives to a plurality of functional components of the crop harvesting implement. A plurality of power sensors detect one or more parameters corresponding to a power consumption by each of the functional components of the crop harvesting machine and generate power signals corresponding to the power consumption by each of the functional components. The power signals are received with an automatic controller which analyzes the power signals and automatically commands operation of an actuator of the crop harvesting implement at least in part in response to at least one of the power signals.

### FIELD OF THE DISCLOSURE

The present disclosure relates to a mower configured to cut crop material, and more particularly to a system for monitoring for performance anomalies in such a mower.

### BACKGROUND

Agricultural equipment, such as a tractor or a self-propelled windrower, includes a prime mover which generates power to perform work. In the case of a tractor, for instance, the prime mover is often a diesel engine that generates power from a supply of diesel fuel. The diesel engine drives a transmission which moves wheels or treads to propel the tractor across a field. In addition to providing power to wheels through a transmission, tractors often include a power takeoff (PTO) which includes a shaft coupled to the transmission and driven by the engine.

In different embodiments, the mower conditioner is a separable machine which is configured to be attached to and detached from a tractor, which either pushes the mower conditioner or pulls the mower conditioner or otherwise carries the mower conditioner. In the separable mower conditioner, the mower conditioner is removably coupled to the tractor and is readily moved from one tractor to another if desired. In these embodiments, the mower conditioner is powered by the PTO of the tractor or a hydraulic motor system thereof.

In another embodiment, the mower conditioner is configured as part of the vehicle and is generally known as a windrower. In the windrower configuration, the mower conditioner is configured as a machine substantially integral with a tractor, such that the mower conditioner is not readily moved from one tractor to another, but instead both the tractor and mower conditioner are integrally designed. In a windrower, the mower conditioner is powered by the prime mover, the PTO, or a hydraulic system including a hydraulic motor.

Mower-conditioners typically operate at a ground speed of from five to ten miles per hour (mph). When the vehicle is operated at this speed, crop moves across a cutting bar, flows past one or more converging augers, where the crop is transferred to a conditioner, and then expelled out the rear of the mower-conditioner to form a windrow. The mower-conditioner may include a merger which transfers the cut material laterally to merge the cut material with other cut material. The uniformity of the formed windrow density (defined as quantity of crop per unit volume) depends not only on the features and function of the mower conditioner, but also on the type and condition of the crop being cut. For instance, cut crop can be light, heavy, sparse, thick, and of variable moisture content.

There is a need for improved systems for monitoring the operation of such a mower-conditioner and for responding automatically to detected anomalies in performance.

### SUMMARY

In one embodiment, a crop harvesting machine includes a cutting bar including a plurality of cutters disposed along an axis which is transverse to a forward working direction of the crop harvesting implement, the cutters being configured to cut the crop material. A cutting bar drive and a cutting bar power sensor are associated with the cutting bar. The cutting bar power sensor is configured to detect one or more parameters corresponding to a power consumption by the cutting bar drive and to generate a cutting bar power signal corresponding to the power consumption by the cutting bar drive. The machine further includes a crop conditioner configured to condition the cut crop material wherein the crop conditioner is located downstream of the cutting bar with respect to the working direction. A conditioner drive and a conditioner power sensor are associated with the crop conditioner. The conditioner power sensor is configured to detect one or more parameters corresponding to a power consumption by the conditioner drive and to generate a conditioner power signal corresponding to the power consumption by the conditioner drive. A controller is operatively associated with the cutting bar power sensor and the conditioner power sensor to receive the cutting bar power signal and the conditioner power signal, respectively, the controller being configured to command operation of at least one functional component of the crop harvesting implement at least in part in response to at least one of the power signals.

In another embodiment a method of operating a crop harvesting implement to cut crop material is provided. The method includes: providing independent drives to a plurality of functional components of the crop harvesting implement; detecting one or more parameters corresponding to a power consumption by each of the functional components of the crop harvesting machine and generating power signals corresponding to the power consumption by each of the functional components; receiving the power signals with an automatic controller; and analyzing the power signals with the controller and automatically commanding operation of an actuator of the crop harvesting implement at least in part in response to at least one of the power signals.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a side elevational view of a windrower including a tractor coupled to a mower conditioner.

FIG. 2 is a front elevational view of a crop harvesting implement.

FIG. 3 is a partial perspective view of the crop harvesting implement taken along the line 3 -3 of FIG. 2.

FIG. 4 is a side elevational view of the partial perspective view of FIG. 3.

FIG. 5 is a side elevational view of another embodiment.

FIG. 6 is a top plan view of a crop harvesting implement.

FIG. 7 is a perspective view of a cutting bar, an undershot rotating element, and first and second converging drums.

FIG. 8 is partial perspective view of another embodiment of a crop harvesting implement.

FIG. 9 is a side elevational view of the partial perspective view of FIG. 8.

FIG. 10 is a schematic drawing of a control system of the crop harvesting implement.

FIG. 11 is a side elevation view similar to FIG. 4 of an alternative embodiment shown from the opposite side of the implement as compared to FIG. 4.

FIG. 12 is an enlarged perspective view of a portion of the implement of FIG. 11 adjacent one end of the converging auger.

FIG. 13 is a schematic of a power distribution and monitoring system.

FIG. 14 depicts a flow chart of one embodiment of a method for monitoring power usage by the various functional components of the crop harvesting machine, the flow chart being broken into two parts indicated as FIGS. 14A and 14B. FIG. 14A details the first portion of the flow chart. FIG. 14B details the second portion of the flow chart.

### DETAILED DESCRIPTION

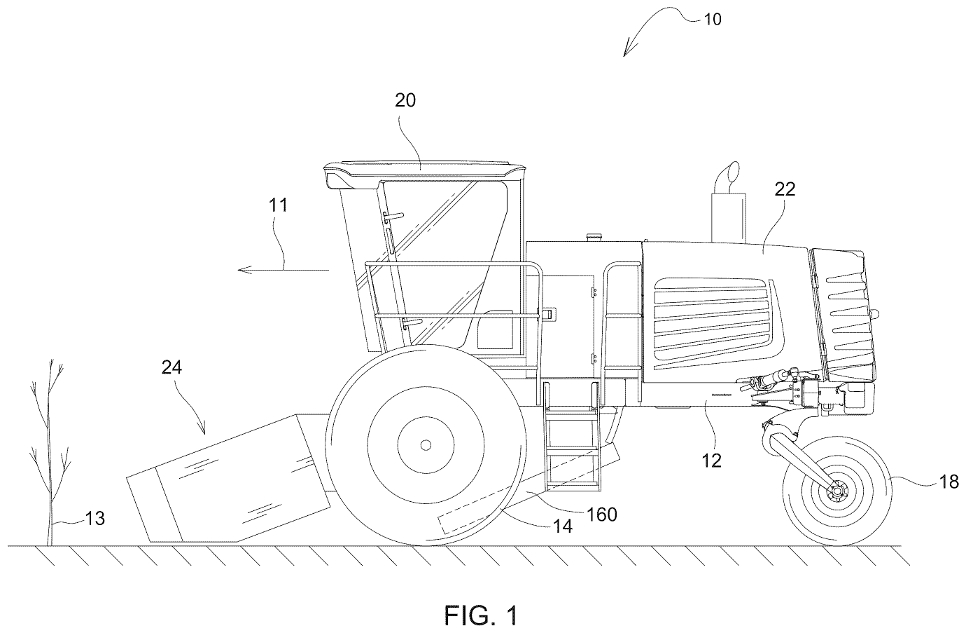

FIG. 1 is a side elevational view a self-propelled crop harvesting machine 10 operable to cut and collect standing crop 13 in a field, condition the cut crop as it moves through a mower conditioner machine to improve its drying characteristics, and then return the cut and conditioned crop material to the field in a windrow or swath. The crop harvesting machine is also known as a mower conditioner or a windrower. The crop harvesting machine 10 moves along the field in a working direction 11. The crop harvesting machine 10 includes a main frame 12 supported on driven right and left front wheels, of which only the left front wheel 14 (with respect to the operator) is shown and on right and left caster mounted rear wheels, of which only a left rear wheel 18 is shown. Carried on a forward end region of the main frame 12 is a cab 20. Mounted on the main frame 12 behind the cab 20 is a housing 22 within which is located a prime mover (not shown), such as an internal combustion engine. A harvesting header 24 is coupled to and supported by the forward end of the main frame 12. As further noted below, the harvesting header 24 may also be referred to as a crop harvesting implement 24. Operator controls (not shown) are provided in the cab 20 for operation of the crop harvesting machine 10, including the attached harvesting header 24. The harvesting header, in one embodiment, includes one or more ground engaging devices, such as one or more skid shoes or wheels (not shown), to support the harvesting header 24 during movement across a field.

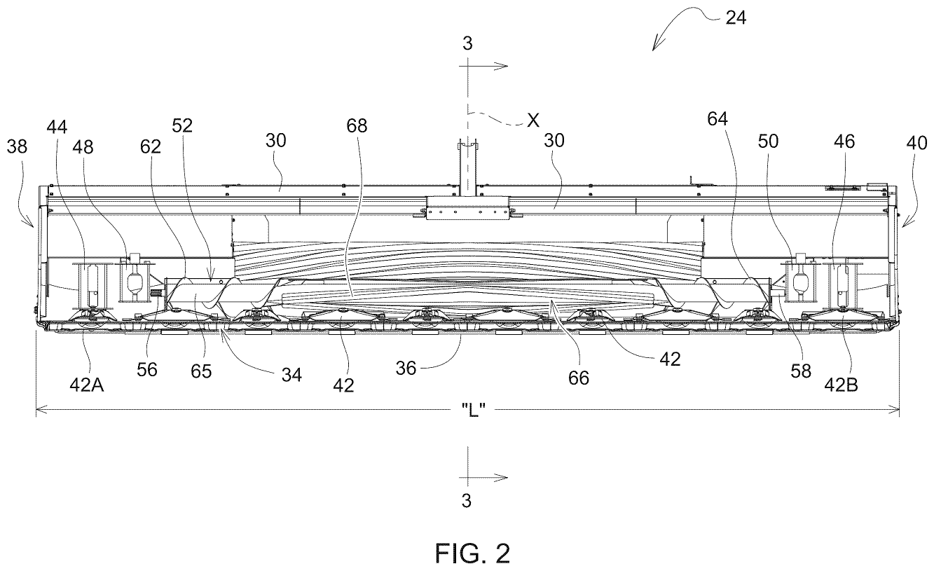

FIG. 2 is an elevational front view of the harvesting header 24. In this view, the harvesting header 24 includes a header frame 30 to which crop cutting and crop conditioners are attached. The header frame 30 may also be referred to as an implement frame 30, and in the context of the crop harvesting implement 24 the implement frame 30 may simply be referred to as a frame 30. As illustrated, the harvesting header extends along a length “L” which defines a crop cutting width provided by a cutting bar 34. The cutting bar 34 is transverse with respect to the moving direction 11 of the windrower 10 of FIG. 1. In one embodiment, the cutting bar 34 is aligned substantially perpendicularly to the moving direction 11 of the windrower 10. It will be understood that when a component is described herein as “supported” from or by the header frame 30 this includes both direct and indirect support. The component may be indirectly supported from the header frame 30 if there is an intervening component supported by the header frame 30 which in turn supports the named component.

In other embodiments having a separable mower conditioner, the mower conditioner is either pushed or pulled by a tractor such that the cutting bar is operated generally perpendicularly to the direction of travel and either parallel to the ground or with the front edge of the cutting bar tipped lower than the back edge. Consequently, the length L, defined by the cutting bar, defines a line generally perpendicular to the direction of travel 11, such that the cutting bar, in different embodiment, operates with a fore-aft tilt or substantially no fore-aft tilt. Windrowers and mowers include such configurations. In any of these embodiments those components as described herein as part of the harvesting header 24 may generally be referred to as a crop harvesting implement 24.

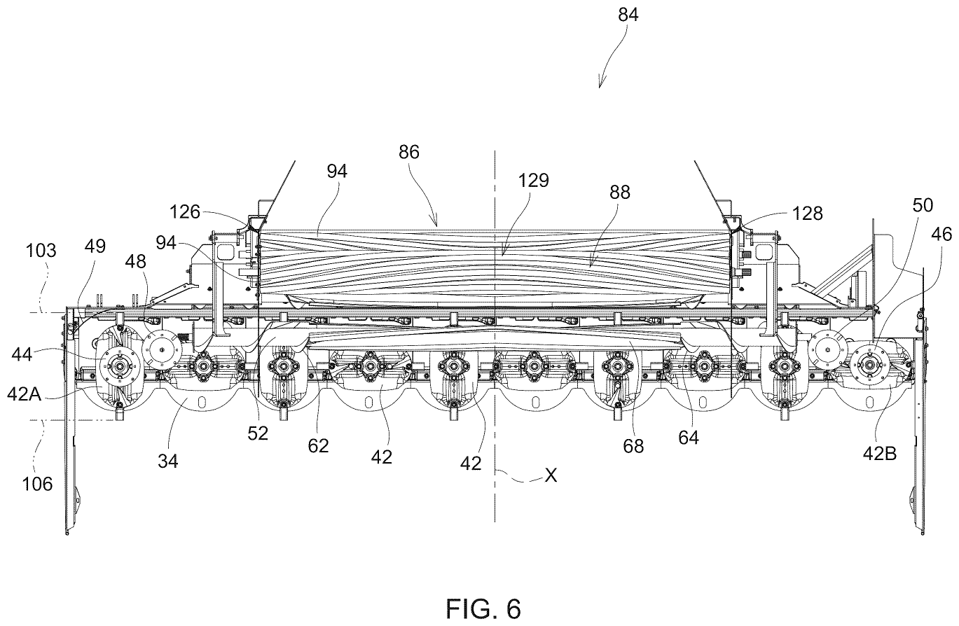

The cutting bar 34 includes a substantially planar support member 36 which extends from a first side 38 of the header frame 30 to a second side 40 of the header frame 30. The support member 36 is configured to support a plurality of rotary cutters 42, or simply cutters 42, each of which is supported by the support member 36 for rotation about respective centers each defining a rotational axis substantially perpendicular to the length L. The plurality of rotary cutters 42 define a rotary cutter zone which extend longitudinally along the cutter bar in which crop is cut and cut crop moves across the rotary cutters. At one end of the cutting bar 34 toward the first side 38, a first converging drum 44 is located above a rotary cutter 42A. A second converging drum 46 is located above a rotary cutter 42B. Each of the first and second converging drums 44 and 46 are operatively connected to the respective rotary cutters 42A and 42B, such that the first and second converging drums move in the same rotational directions as the respective rotary cutter 42A and 42B. The rotary cutters 42 may be arranged along the length of the support member 36 such that the rotary cutters 42 located leftward of a center line X, as illustrated, are driven in a counterclockwise direction when viewed from above and the rotary cutters 42 located rightward of the center line X are driven in a clockwise direction when viewed from above. See FIG. 6.

In one embodiment, the rotational direction of the cutters is generally toward the center with the front edge of the cutting bar such that the cutters located on the left-hand side of the drawing (the right-hand side of the cutting bar in the direction of operation) is counterclockwise. The rotational direction of the cutters on the right-hand side of FIG. 6 is clockwise. In other embodiments, the cutters located inboard of either the conditioner or the converging means are configured to rotate as pairs. As seen in FIG. 6, the outer two cutters on each end of the cutting bar rotate toward center, but the remaining cutters, in other embodiments, rotate as counter-rotating pairs. Other rotational patterns of the cutters may be used. For example, in one embodiment the cutter 42A may rotate clockwise and the cutter 42B may rotate counterclockwise.

A third converging drum 48 is located adjacently to the converging drum 44 and may rotate in the same direction as the converging drum 44. A fourth converging drum 50 is located adjacently to the converging drum 46 and may rotate in the same direction as the converging drum 46. Each of the converging drums 48 and 50 may be driven by a belt (not shown) which operatively couples each drum 48 and 50 to adjacent drums 44 and 46. The converging drums 48 and 50 are smaller than the converging drums 44 and 46. Due to the rotation of the converging drums, crop cut toward the sides 38 and 40 is directed toward the centerline X.

As further seen in FIG. 6, an arcuate shaped deflector plate 49 may be supported directly or indirectly from the header frame 30.

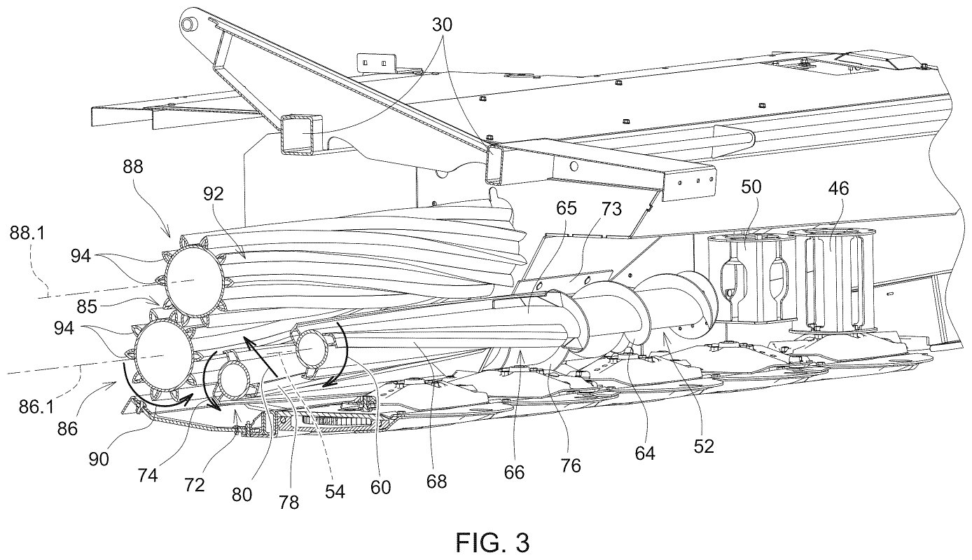

An undershot rotating element 52 is supported by the header frame 30 for rotational movement about a rotational axis 54. The undershot rotating element 52 may also be referred to as a first converging auger 52. See FIG. 3. The undershot rotating element 52 includes a length which extends along the longitudinal direction and between the converging drum 48 and 50. As illustrated, a first end 56 and a second end 58 are supported for rotation about the rotational axis 54 in a rotational direction 60 as illustrated in FIG. 3. Located adjacently to the first end 56 is a first flighting 62 and located adjacently to the second end 58 is a second flighting 64. The flightings extend from and are coupled to a cylindrical portion 65. The flightings 62 and 64 are arranged to move cut crop toward the centerline X and to a paddle section 66. The auger flighting moves cut crop toward the center of the machine. The paddle section 66 includes a plurality of paddles 68 each of which extends from and is coupled to the cylindrical portion 65. The paddles 68 extend between each of the first flighting 62 and the second flighting 64. The paddles 68 include a curved profile with respect to the rotational axis 54 and having end portions disposed adjacently to the first flighting 62 and second flighting 64 to contact cut crop. The paddles are located in key areas where the predominant direction of motion of the rotary cutters is to the front of the header 24. The paddles are configured to move the cut crop to the rear of the machine, with little movement of the crop towards the center of the paddles. The curve profile of the paddles reduces or substantially eliminates power spikes which could occur if the paddles were not curved, but were instead straight across. Cut crop, therefore, is moved away from the converging drums 48 and 50 toward the centerline X by the flightings 62 and 64 where it is pushed toward the rear of the rotary cutters 42 by paddles 68 and toward an overshot rotating element 72 of FIG. 3. The overshot rotating element 72 may also be referred to as a second converging auger 72. One or more angle shaped scrapers 73 may be fixed directly or indirectly to the header frame 30, and may be generally referred to as a fixed structure 73 fixed relative to the header frame 30. As used herein, terms undershot and overshot rotating elements can also be identified as undershot augers or overshot augers when having the included flightings which are configured to move cut crop in a fashion similar to an auger.

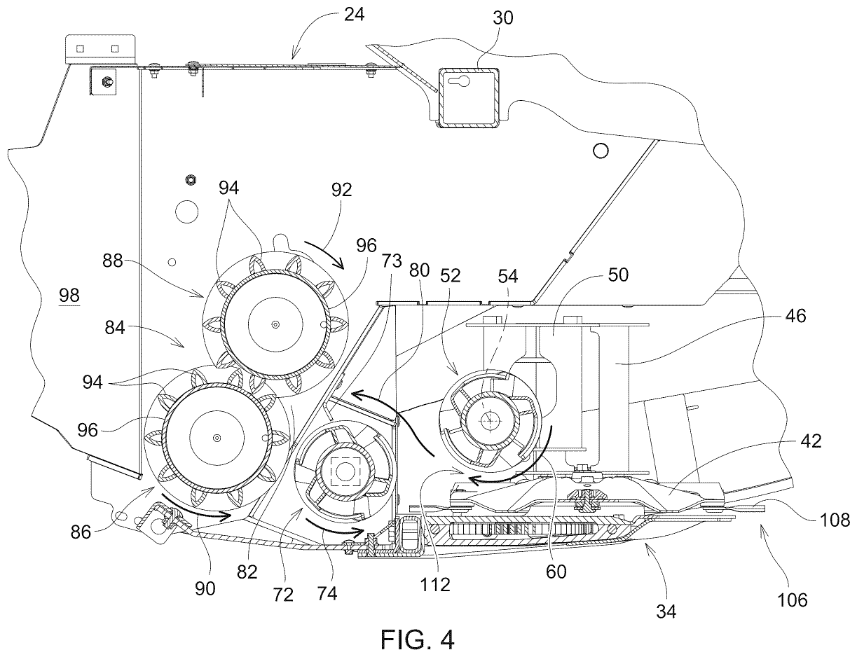

The overshot rotating element 72 is supported by the header frame 30 for rotational movement in a direction 74 which is opposite the rotational direction 60 of the undershot rotating element 52. In one embodiment and as illustrated in FIG. 3, the overshot rotating element 72 includes crop movement features of the same type as the undershot rotating element 52. The overshot rotating element 72, therefore includes first and second flightings, one of which, flighting 76, is shown. A paddle section 78 is disposed between the first and second flighting. The opposed rotations of undershot rotating element 52 and overshot rotating element 72 move the cut crop between the two augers 52 and 72 along a path 80. See also FIG. 4. The path 80 extends toward an interface 82 located at a crop conditioner 84, which in the illustrated embodiment includes a first conditioner roll 86 and a second conditioner roll 88. A further illustration of the path 80 of the cut crop through the crop harvesting machine is seen in FIG. 11.

Although the present disclosure illustrates a crop harvesting machine including both converging drums and a converging auger, it will be understood that some crop harvesting machines do not include any converger apparatus at all. Many aspects of the present disclosure are applicable to crop harvesting machines that do not include a converger apparatus.

The first conditioner roll 86 moves in a direction 90 which is opposite a direction 92 of the second conditioner roll 88. Each of the conditioner rolls 86 and 88 include a plurality of extensions or splines 94 extending from a cylindrical portion 96. The splines 94 of one roll 86 mesh with the splines 94 of the other roll 88 such that the cut crop moving along the path 80 and into the interface 82 is conditioned by pressing, crushing, or breaking the cut crop to reduce the rigidity of the cut crop, as well as to remove or at least release a waxy outer layer which can be found in the cut crop depending on the type of cut crop being conditioned. After cutting, the crop is conditioned by passing between the roll 86 and the roll 88 and out a back portion 98 of the harvesting header 24. The cut crop then moves to the field where it remains until use or collection.

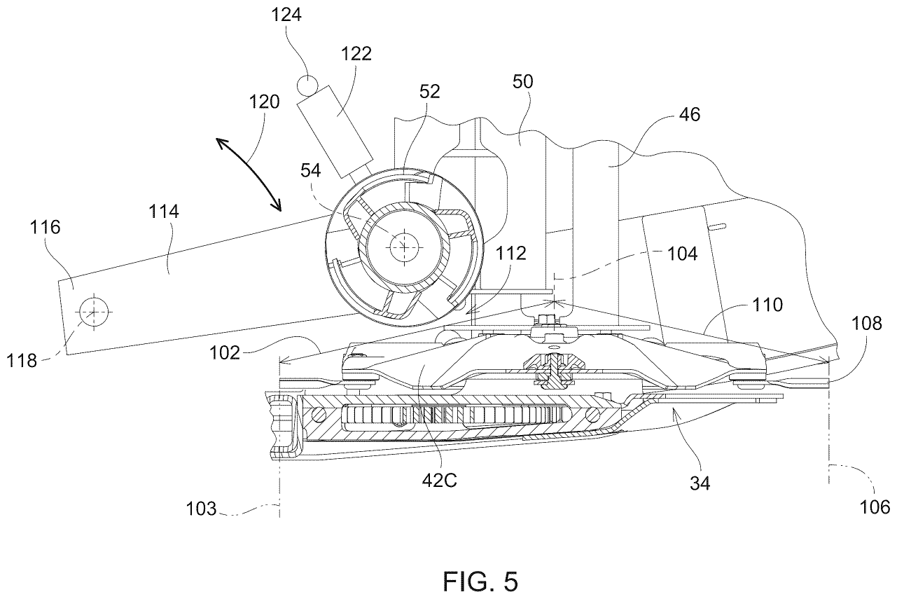

As can be seen in FIGS. 4 and 5, the undershot rotating element 52 may be supported above at least a portion of the cutting bar 34 and may be generally subtended by the plurality of rotary cutters 42, one of which, rotary cutter 42C, is shown. The cutting bar 34, therefore, underlies the plurality of rotating elements 52. In one embodiment as illustrated, a rotational axis 54 of the undershot rotating element 52 extends along the length of the cutting bar 34 and is generally disposed along and above a trailing portion 102 of the line of rotary cutters 42. As can be seen, the trailing portion 102 extends from a rotational axis 104 of the illustrated rotary cutter 42C to a trailing edge 103 of the cutter 42C along an incline defined by the rotary cutter. In other embodiments, the rotational axis 54 of the undershot rotating element 52 is disposed substantially directly above the rotational axis 104, disposed substantially above the trailing edge 103, or positioned at a location therebetween.

Placement of the rotational axis 54 above the trailing edge 103 places the flightings 62 and 64 and the paddle section 66 above the trailing edge 103 of each of the rotary cutters 42 which, in one embodiment, are transverse to the moving direction 11. In other embodiments, the position is generally aligned perpendicularly to the moving direction 11. The cut crop, which is cut at a leading edge 106, defined by a plurality of rotary cutter knives 108, moves across a leading portion 110 of the rotary cutters 42 and falls to the exposed surfaces of the rotary cutters 42 of both the leading portion 110 and a part of the trailing portion 102, depending on the location of the undershot rotating element 52. Crop moves from an input of the harvesting header 24 at the leading portion and exits though an output located after the crop conditioner 84 at the back portion 98.

The cut crop is moved by rotation 60 of the rotating element 52 into a space 112 defined between the outer edges of the flightings 62 and 64 and the paddle section 66 of the rotating element 52 and the rotary cutters 42.

In the embodiment of FIG. 4, this space is approximately 1.2 inches and remains substantially fixed along the length of the rotating element 52. The auger flight diameter is slightly larger than the paddle diameter, so this dimension of approximately 1.2 inches is slightly greater in the area of the paddles than under the flights. Each of the ends of the rotating element 52 is operatively connected to the header frame 30 for rotation about the rotational axis 54. In FIG. 4, the rotational axis 54 does not move with respect to the cutting bar 34 since the ends of the rotating element 52 are fixedly located for rotation at the header frame 30.

In another embodiment of FIG. 5, each end of the rotating element 52 is fixed to an arm, one of which is shown as arm 114 FIG. 5. Other types of linkages are used in different embodiments. A first end 116 of the arm 114 is rotatably coupled to the header frame 30 at a pivot location 118 about which the arm rotates in either a clockwise or counterclockwise direction 120. The arms 114, and therefore the rotating element 52, “floats” above, or moves with respect to an amount of the cut crop located between the undershot rotating element 52 and the rotary cutters 42. Consequently, while the rotating element 52 fixedly rotates about the axis 54, the axis 54 moves along an arc defined by the direction 120. Floating of the rotating element 52 provides additional clearance for heavy crop conditions. In FIG. 5, movement of the arm 114 is dampened in both directions 120 by a resilient element 122, such as a double acting hydraulic actuator, having one end coupled to one end of the arm or one end of the rotating element 52 and an end 124 fixed to the header frame 30. The resilient element 122 dampens movement of the rotating element 52 which moves away from the cutting bar 34 if the amount of cut crop moving between the rotary cutters 42 and rotating element 52 increases sufficiently to cause movement of the rotating element 52 away from the rotary cutters. In one embodiment, the distance between the rotating element 52 and the rotary cutters 42 of FIG. 5, when the rotating element 52 is at a resting position, is the same distance between the rotating element 52 and rotary cutters 42 defining the space 112 in FIG. 4. In other embodiments, however, the distance between the rotating element 52 and the rotary cutters 42 defining the space 112 is different, since rotating element 52 is supported by the arm 114 for movement with respect to the rotary cutters 42.

In other embodiments, the resilient element 122 restricts movement of the rotating element 52 away from the rotary cutters 42, while only the weight of the rotating element 52 moves the rotating element toward the rotary cutters 42. In this embodiment, a single acting hydraulic actuator is used. In other embodiments, the resilient element 122 includes elastic springs, mechanical springs or gas springs. In still other embodiments, the resilient element is located at or near the pivot location 118.

As described herein, the placement of the undershot rotating element 52 with respect to the cutting bar 34, and in particular to the rotational axis of the rotary cutters 42, positively moves the crop across the rotary cutters 42 and to the crop conditioner 84. The location of the auger at the trailing edges of the rotary cutters provides a positive directional movement of the cut crop instead of allowing it to hesitate on the top of the rotary cutters 42. Additional crop directional control devices, such as curtains or drapes to direct the cut crop, are therefore unnecessary. Consequently, not only is the cost of the crop directional control devices avoided, but clogging issues associated with such devices is avoided as well.

FIG. 6 illustrates a top plan view of the cutting bar 34, rotary cutters 42, the undershot rotating element 52, and the crop conditioner 84. As can be seen, the splines 94 of each of the conditioner rolls 86 and 88 extends along the length thereof a distance which is greater that the distance spanned by the paddles 68 of the undershot rotating element. The length of the splines 94 extends longer than the length of the paddles 68 such that the ends of splines 94 terminate at a first location 126 and a second location 128. Consequently, cut crop, which is not sufficiently moved by the flightings 62 and 64 toward the center of the undershot rotating element, is still moved into the crop conditioner 84 for conditioning. As seen in FIG. 6, the splines 94 are curvilinear, wherein the outer ends of the splines 94 lead the center section of the splines 94 in the direction of rotation. In another embodiment, the center section of the splines 94 leads the ends in the direction of rotation.

In FIG. 6, rotary cutters 42 are shown in one stationary position to illustrate that every other rotary cutter 42 is aligned at an angle of approximately ninety degrees with respect to an adjacent rotary cutter 42. As seen in FIG. 6, the trailing edge 103, as also seen in FIG. 5, is determined by the rotary cutter knife 108 at its full extension away from the rotary cutters 42.

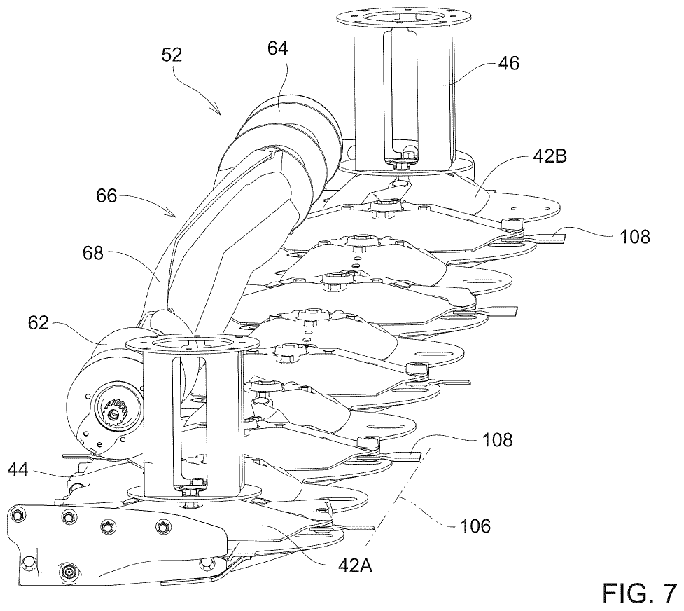

FIG. 7 illustrates a perspective view of the undershot converging auger 52 disposed above the rotary cutters 42 supported by the cutting bar support 36 and converging drums 44 and 46 of FIG. 2. In this embodiment, however, the converging drums 48 and 50 are not included. A drive mechanism (not shown) extends through the converging drums 44 and 46 to move the rotary cutters 42A and 42B. In other embodiments, the converging drums 44 and 46 are not included and are not required for operation of the undershot rotating element 52.

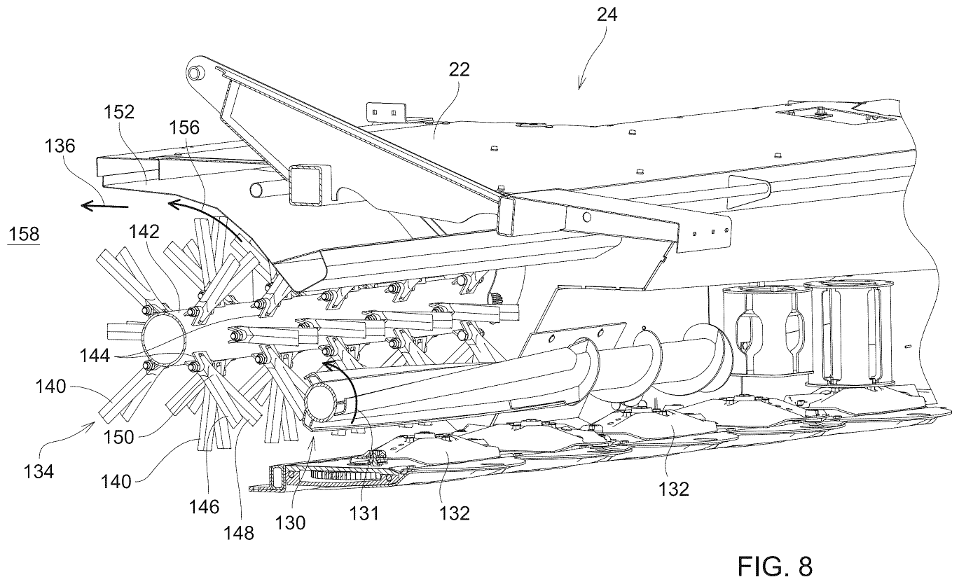

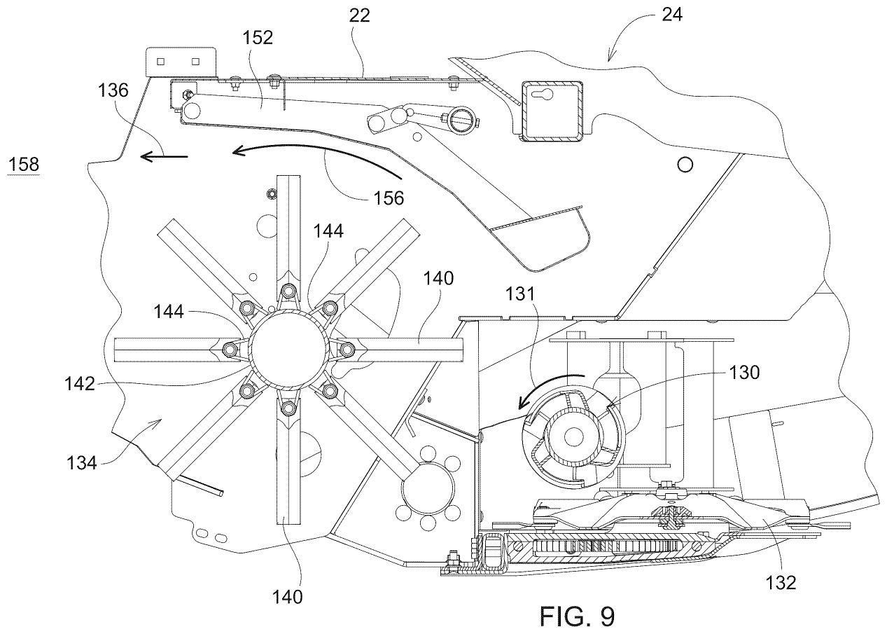

FIGS. 8 and 9 illustrate another embodiment of the present disclosure including a converging auger 130, rotating in a direction 131 as illustrated, located above at least a portion of, or subtended by, a plurality of rotary cutters 132. The converging auger 130 is subtended by a trailing edge of the rotary cutters 132, which has been previously described with respect to other embodiments. In this embodiment, the overshot converging auger 72 of FIG. 4 is not included and an impeller conditioner 134 is used instead of the crop conditioner 84 of FIG. 4. The impeller conditioner 134 rotates in a direction 136 and conditions cut crop which is received after being directed between the rotating element 130 and the rotary cutters 132 of the harvesting header 24.

The impeller conditioner 134 includes a plurality of projecting elements or tines 140 which extend from a cylinder 142. Each of the tines 140 are coupled to the cylinder 142 at a plurality of brackets 144 extending from the cylinder 142. The tines 140 include a Y shaped configuration having a first leg 146 and a second leg 148 extending from a central portion 150 coupled to the bracket 144. The Y-shaped tine 140 is loosely coupled to the bracket 144 such that rotation of the cylinder 142 causes the tines to flail against the cut crop to condition the crop.

The harvesting header 24 includes shield 152 supported by the housing 22 and/or frame (not shown). The shield 152 is spaced from ends of the first leg 146 and second leg 148 to provide a passage 156 for the cut crop which is moved by the rotating element 130 toward the impeller conditioner 134 and upwardly toward the exposed surface of the shield 152. Contact of the tines 140 with the cut crop moving though the passage 156 forces the cut crop toward the shield 152 such that the cut crop is conditioned by movement through the passage 156. The conditioned cut crop then moves to an exit 158 where it is deposited in the field, as previously described.

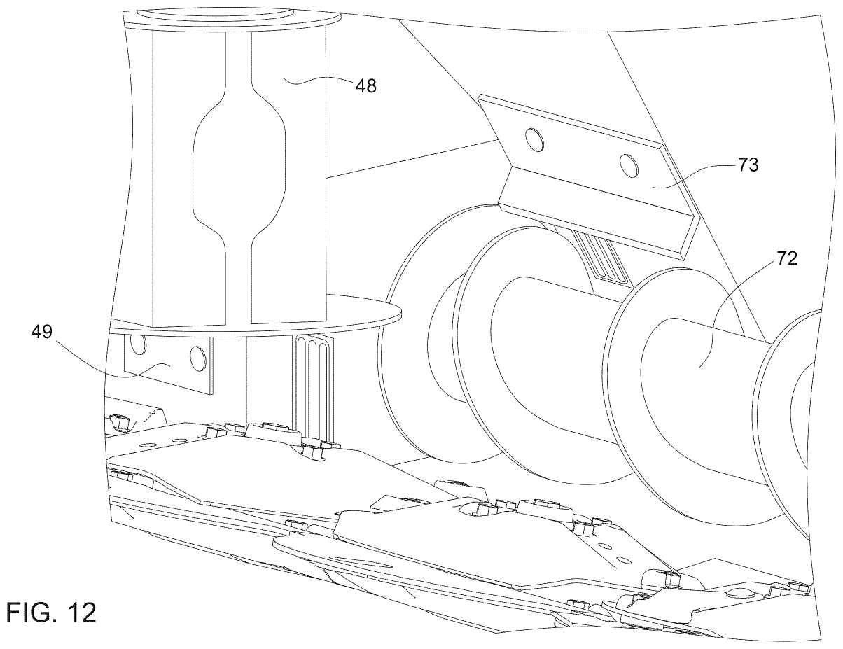

In a still further embodiment as schematically shown in FIGS. 11 and 12 the crop harvesting machine may include only the second converging auger 72 and does not include the first converging auger 52. FIG. 11 is similar in content to FIG. 4 but is viewed from the opposite side of the machine 10 as compared to FIG. 4. FIG. 12 is an enlarged perspective view in the area of the first end 72.1 of the converging auger 72 and in the area of the converging drum 48.

Any of the converging augers 52, 72 or 130, or any of the converging drums 44, 46, 48 or 50 may be described as a crop converging mechanism or simply as a converger. The crop converging mechanism may also take other forms, such as paddles or a conveyor.

In some embodiments the machine 10 may further include a hay merger 160 suspended below the main frame 12 for receiving cut crop material from the crop conditioner 84 and transferring the cut crop material in a lateral direction to merge the same with other cut crop material from a previous pass by the machine 10, or from another crop harvesting machine. The hay merger 160 may include an endless conveyor belt in a known configuration.

### Independent Drive System

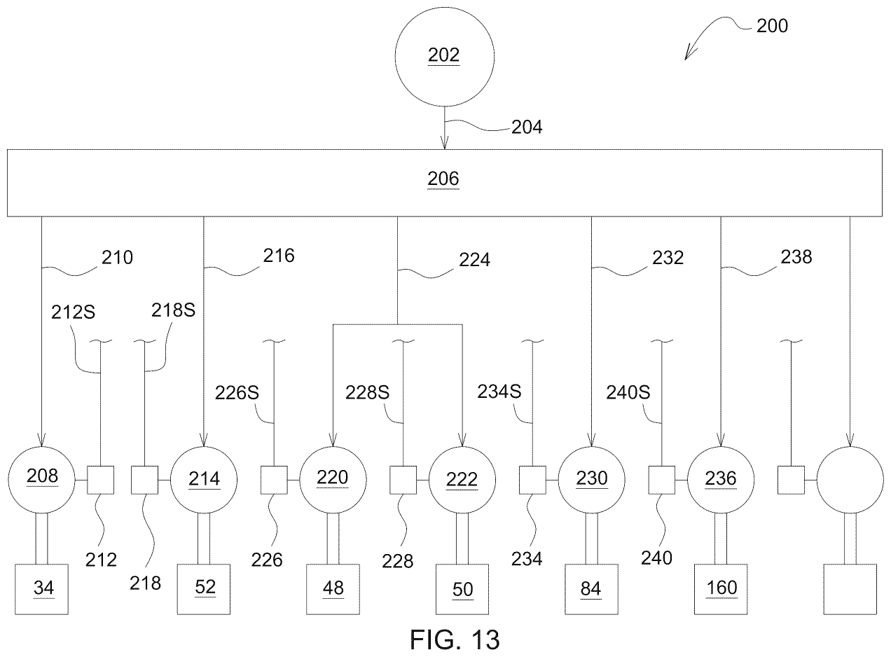

The present disclosure provides a system of independent drives for each of the various functional components of the crop harvesting machine 10. This allows the power consumption of the various functional components to be monitored to detect various operational anomalies occurring in the crop harvesting machine 10. As schematically shown in FIG. 13, the crop harvesting machine 10 includes a power distribution and monitoring system generally designated as 200.

The power distribution and monitoring system 200 includes a power source 202. A power output 204 from the power source 202 is distributed to the various functional components of the crop harvesting machine 10 by a power distribution system 206. The functional components of the crop harvesting machine 10 may include the previously noted cutting bar 34, converging auger 52, left and right converging drums 48 and 50, crop conditioner 84, hay merger 160, and other functional components such as the drives for the front and/or rear wheels 14 and 18. Each of the functional components may have associated therewith an independently powered and independently controllable drive for that component.

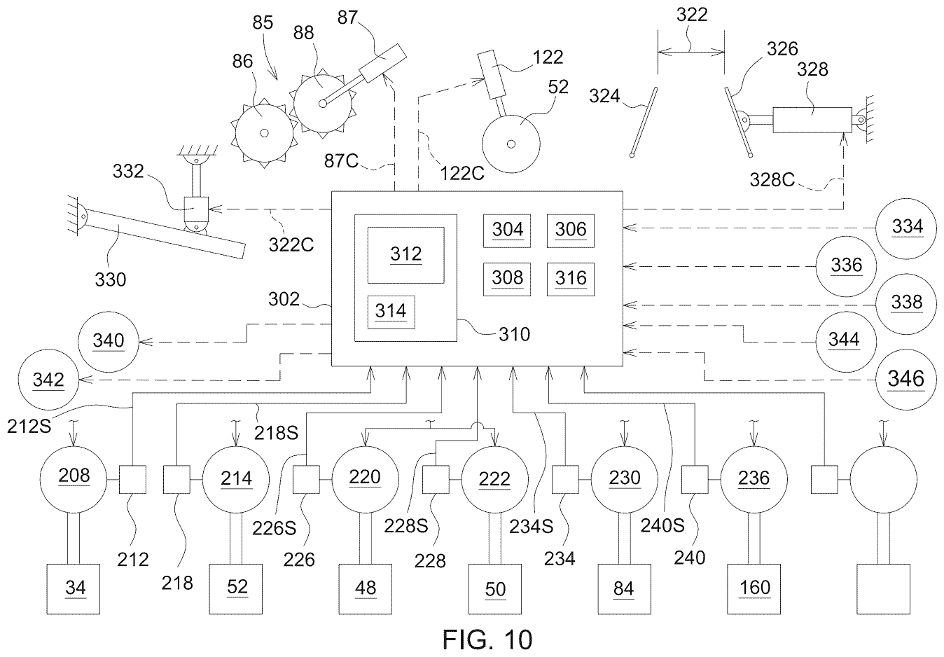

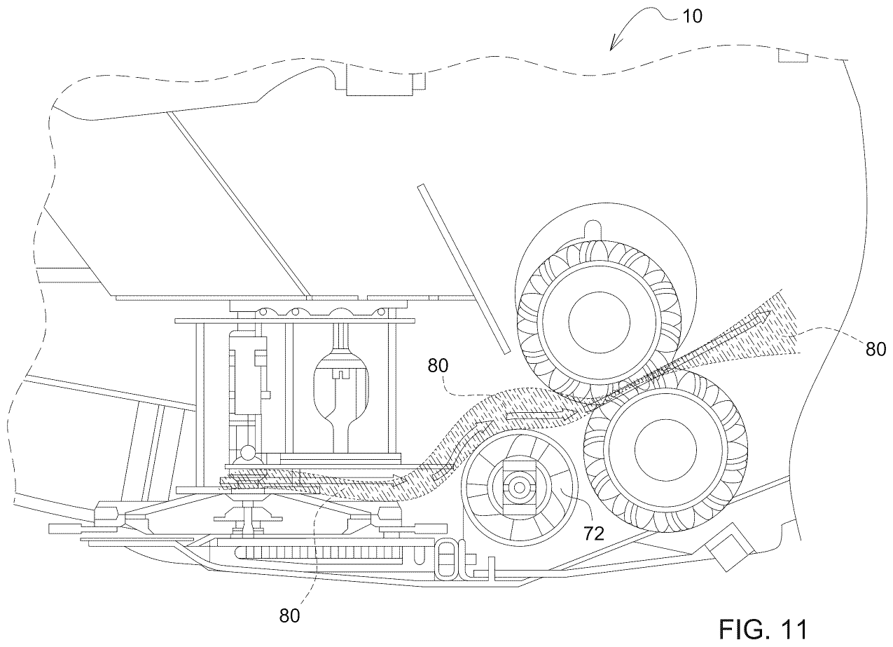

The cutting bar 34 may be driven by a cutting bar drive 208 which consumes a power sub-stream 210 to drive the cutting bar 34. A cutting bar power sensor 212 is configured to detect one or more parameters corresponding to the power consumption 210 by the cutting bar drive 208 and to generate a cutting bar power signal 212S (see FIG. 10) corresponding to the power consumption by the cutting bar drive 208.

The converging auger 52 may be driven by a converger drive 214 which consumes a power sub-stream 216 to drive the converging auger 52. A converger power sensor 218 is configured to detect one or more parameters corresponding to the power consumption 216 by the converger drive 214 and to generate a converger power signal 218S (see FIG. 10) corresponding to the power consumption by the converger drive 214.

The left and right converging drums 48 and 50 may be driven by converging drum drives 220 and 222 which consume a power sub-stream 224 to drive the left and right converging drums 48 and 50. Converging drum power sensors 226 and 228 are configured to detect one or more parameters corresponding to the power consumption 224 by the converging drum drives 220 and 222 and to generate converging power signals 226S and 268S (see FIG. 10) corresponding to the power consumption by the converging drum drives 220 and 222.

The conditioner 84 may be driven by conditioner drive 230 which consumes a power sub-stream 232 to drive the crop conditioner 84. A conditioner power sensor 234 is configured to detect one or more parameters corresponding to the power consumption 232 by the conditioner drive 230 and to generate a conditioner power signal 234S (see FIG. 10) corresponding to the power consumption by the conditioner drive 230.

The hay merger 160 may be driven by a merger drive 236 which consumes a power sub-stream 238 to drive the hay merger 160. A merger power sensor 240 is configured to detect one or more parameters corresponding to the power consumption 238 by the merger drive 236 and to generate a merger power signal 240S (see FIG. 10) corresponding to the power consumption by the merger drive 236.

The various drives 208, 214, 220, 222, 230 and 236 may take different forms. For example, one or more of the drives may be in the form of a hydraulic drive motor in which case its respective power sub-stream may take the form of a hydraulic line providing hydraulic fluid under pressure to the drive. In this case the power source 202 may include a hydraulic pump to provide the pressurized hydraulic fluid, and the power distribution system 206 may include hydraulic lines and hydraulic control valves controlled by the control system 300 further described below. In the case of a hydraulic drive motor the associated power sensor may take the form of a hydraulic pressure sensor and/or a hydraulic flow sensor, from which the hydraulic power consumed by the hydraulic motor may be determined. In this case the one or more parameters may include hydraulic pressure and/or hydraulic flow rates.

In another example, one or more of the drives may be in the form of an electric drive motor in which case its respective power sub-stream may take the form of an electrical conduit providing electric power to the drive. In this case the power source 202 may include a battery or other source of stored electric power. Alternatively in this case the power source may include an electric generator driven by a prime mover such as an internal combustion engine. In the case of an electric drive motor the associated power sensor may take the form of an electrical power sensor for measuring the electrical power consumption by the electric drive motor. In this case the one or more parameters may include electric voltage and/or electric current.

In another example, one or more of the drives may be a mechanical drive which is directly mechanically driven from the power source 202, in which case the power source 202 may include a prime mover such as an internal combustion engine which is mechanically connected to the mechanical drive. In the case of a mechanical drive the associated power sensor may take the form of a torque sensor or the like which is configured to detect and measure mechanical power consumption. In this case the one or more parameters may include torque.

In another example, the drives of the machine 10 may include a combination of one or more hydraulic drive motors and/or one or more electric drive motors and/or one or more mechanical drives.

### The Control System

As schematically illustrated in FIG. 10, the crop harvesting machine 10 may include a control system 300 including a controller 302. The controller 302 is configured to receive input signals from the various sensors, such as the power signals 212S, 218S, 226S, 228S, 234S and 240S from the power sensors 212, 218, 226, 228, 234 and 240, respectively. The signals transmitted from the various sensors to the controller 302 are schematically indicated in FIG. 10 by lines connecting the sensors to the controller with an arrowhead indicating the flow of the signal from the sensor to the controller 302.

The controller 302 may also monitor one or more crop conditions of the cut crop material passing through the crop harvesting machine. At least one crop condition sensor 334 may be configured to detect at least one condition of the cut crop material flowing through the crop harvesting machine. The crop condition sensor may be a moisture sensor for detecting a moisture content of the cut crop material. The crop condition sensor may be a Near Infrared (NIR) sensor which may detect the concentration of leafy matter in the cut crop material. The crop condition sensor may be a weight sensor for detecting the weight of a stream of cut crop material passing through a conveyor or other component of the crop harvesting machine. The crop condition sensor may be an imaging sensor configured to detect a shape of the cut crop material either within the crop harvesting machine or as that material is deposited on the ground by the crop harvesting machine.

The controller 302 may also monitor various machine operating parameters. Machine advance speed may be monitored via speedometer 336. Cutting drive speed may be monitored with a cutting drive speed sensor 338. Propulsion power for the crop harvesting machine may be monitored, for example by measuring wheel torque and rotational velocity with a torque sensor 344 and a rotational wheel speed sensor 346.

Similarly, the controller 302 will generate control signals for controlling the operation of the various actuators such as actuators 87, 122, 328 and 332 discussed below. The controller 302 may also generate control signals for the operation of other machine actuators such as a machine advance drive speed control actuator 340 and a cutting bar speed control actuator 342. The controller 302 may also generate control signals for adjustment of various other mowing machine parameters such as header lift height, header tilt, float pressure to control the down force on the header, and merger speed settings.

The controller 302 may be described as being operatively associated with the cutting bar power sensor 212, the conditioner power sensor 234 and the converger power sensor 218 or 226, 228, to receive the cutting bar power signal 212S, the conditioner power signal 234S and the converger power sensor 218S or 226S, 228S, respectively, the controller 302 being configured to command operation of an actuator or other functional component of the crop harvesting implement at least in part in response to at least one of the power signals. The actuator may include the actuators 87, 122, 328 and 332 discussed below. The actuator may also include an actuator controlling a machine parameter such as advance speed or operational speed of one of the functional components. Thus the actuator could control the operational speed of the cutter drive 208, or the converging auger drive 218, or the converging drum drives 220 and 222, or the conditioner drive 230, or the merger drive 236, or an advance drive for the wheels 14 and/or 18.

Controller 302 includes or may be associated with a processor 304, a computer readable medium 306, a data base 308 and an input/output module or control panel 310 having a display 312. An input/output device 314, such as a keyboard, joystick or other user interface, is provided so that the human operator may input instructions to the controller. It is understood that the controller 302 described herein may be a single controller having all of the described functionality, or it may include multiple controllers wherein the described functionality is distributed among the multiple controllers.

Various operations, steps or algorithms as described in connection with the controller 302 can be embodied directly in hardware, in a computer program product 316 such as a software module executed by the processor 304, or in a combination of the two. The computer program product 316 can reside in RAM memory, flash memory, ROM memory, EPROM memory, EEPROM memory, registers, hard disk, a removable disk, or any other form of computer-readable medium 306 known in the art. An exemplary computer-readable medium 306 can be coupled to the processor 304 such that the processor can read information from, and write information to, the memory/storage medium. In the alternative, the medium can be integral to the processor. The processor and the medium can reside in an application specific integrated circuit (ASIC). The ASIC can reside in a user terminal. In the alternative, the processor and the medium can reside as discrete components in a user terminal. The term “processor” as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

The term “processor” as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

The control panel 310 may for example be physically located on the crop harvesting machine 10, for example in the cab 20, such that the control panel 310 is supported directly or indirectly from the frame 12. Optionally, or additionally, the control panel 310 or some portion thereof may be remotely located, such as on a tractor or on a handheld device carried by a human operator. Further, in the event of an autonomous machine 10 the control panel 310 or some portion thereof may be located at a remote-control station and may be communicated with the controller 302 wirelessly.

The controller 302 may be configured to adjust an actuator, such as 87, to adjust a width of a passage through which the cut crop material flows. For example, as seen in FIG. 3, the crop conditioner 84 may include the first conditioner roll 86 supported by the header frame 30 for rotation about a first conditioner roll axis 86.1 and the second conditioner roll 88 supported by the header frame 30 for rotation about a second conditioner roll axis 88.1. The first conditioner roll 86 and the second conditioner roll 88 may be configured to rotate in opposite directions about each of the respective conditioner roll axes 86.1, 88.1. The “passage” through which crop material flows may be a conditioning gap 85 between the conditioner rolls 86 and 88. That conditioning gap 85 may be adjusted by an actuator 87 schematically shown in FIG. 10.

The controller 302 may send a command signal 87C to the actuator 87 to control the same. It will be understood that the command signal 87C may be in the form of an electrical signal sent to an electro-hydraulic control valve (not shown) associated with the actuator 87, so that a hydraulic flow to the actuator 87 is controlled in response to the electrical command signal 87C.

In another embodiment as schematically shown in FIG. 10, the “passage” through which crop material flows may be a forming gap 322 between a pair of adjustably angled forming shields 324 and 326 located downstream of the crop conditioner 84. An actuator 328 may adjust the forming gap 322 in response to a command signal from controller 302. In another embodiment, the “passage” through which crop material flows may be the space 112 between the converging auger 52 and the rotary cutters 42 as seen in FIG. 5, and the dimension of that passage may be adjusted with actuator 122. The controller 302 may send a command signal 122C to the actuator 122.

In another embodiment, the passage may be a flow path of the cut crop material adjacent the swathgate 330 and the actuator may be a swathgate actuator 332, as schematically shown in FIG. 10.

As noted above the present disclosure provides a system of independent drives for each of the various functional components of the crop harvesting machine 10. This allows the power consumption of the various functional components to be monitored to detect various operational anomalies occurring in the crop harvesting machine 10. For example, in one embodiment the controller 302 may be configured to compare an aggregate power consumption of the crop harvesting implement to the power consumption of one or more of the drives of one of the functional components to monitor for a performance anomaly in the one or more of the drives. In another embodiment, the controller 302 may be configured to compare the power consumption of a first one of the drives to the power consumption of another one of the drives to monitor for a performance anomaly in the first one of the drives or the other of the drives. The detected performance anomaly may for example be a plugging of one of the functional components by the cut crop material.

With regard to the configuration of the controller 302 to compare an aggregate power consumption of the crop harvesting implement to the power consumption of one or more of the drives of one of the functional components, the aggregate power consumption may be a total power consumption by all the functional components or it may be the aggregate power consumption by some group of the functional components. In either case, the controller 302 may be configured to determine an expected or normal power consumption by each of the functional components as a percentage of the aggregate power consumption. Then by monitoring the current power consumption by each of the functional components the controller 302 may compare the current power consumption for a given functional component to the expected or normal power consumption of that functional component, as a percentage of the aggregate power consumption for the crop harvesting implement. Then depending upon the design of a given functional component an unusually high or low power consumption by that functional component may be identified as corresponding to a particular performance anomaly.

The normal or expected power consumption of a given component may be established as a threshold value. The controller 302 may be configured to identify operational values that are satisfactory as they are within the expected threshold, or cautionary as they are beginning to exceed the expected threshold, or requiring immediate remedial action if they are substantially exceeding the expected threshold. The comparison thresholds may be configurable based on operator input to the user interface of the controller, and/or they may be determined by the controller 302 automatically based on analysis of historical data or predictions based on other machine parameters and known operational relationships of the machine components.

With regard to the configuration of the controller 302 to compare the power consumption of a first one of the drives to the power consumption of another one of the drives the controller 302 may be configured to identify specific performance anomalies indicated by specific combinations of power consumption.

For example, the controller may compare the power consumption by the conditioner drive 230 and the merger drive 236. If the crop harvesting implement is operating properly then the power consumption by each of the conditioner drive 230 and the merger drive 236 will be in its normal range. But if the conditioner 84 becomes plugged with cut crop material, the power consumption by the merger drive 236 may drop to a value much lower than normal because the merger 160 is not carrying any cut crop material, and the power consumption by the conditioner drive 230 may remain normal or above normal as it tries to move a heavy load of material. Thus the controller 302 may be configured to detect plugging at the conditioner 84 when the conditioner power consumption 232 is normal or greater than normal and the merger power consumption 238 is zero or lower than normal.

In another example the controller may be configured to detect plugging of the converging auger 52 by comparing the power consumption of the cutting bar drive 208 and the converging auger drive 214. The converging auger drive 214 may be configured such that the power consumption by the converging auger drive 214 is a function of the rotational speed of the converging auger drive 214. Thus, if the converging auger drive 214 becomes plugged and the converging auger 52 cannot rotate, the converging auger power consumption 216 may drop to zero or a value lower than normal. If that happens, and if the power consumption 210 by the cutting bar drive 208 remains at normal levels, this is an indication of plugging at the converging auger 52.

Depending on the design of a given one of the drives and the manner of monitoring the power consumption by that drive, a plugging of that component which prevents rotation of the drive may result in a power consumption by that drive that is higher or lower than would otherwise be expected in view of the operational status of the other components of the crop harvesting implement.

In another example when positive propulsion power is detected (wheel torque×rotational velocity×rolling radius) along with abnormally high converging power (auger belt tension×belt speed) with normal conditioner measures (gap, speed, pressure), this may be an early indication of an auger wrap where the cut crop material is wrapping around the converging auger. Early detection allows the potential plugging situation to be cleared more easily. Other adjustments such as scraper clearance adjustment and cutting drive speed may be made. Such early adjustments may reduce downtime of the machine.

In another example, abnormally high propulsion power with normal header power and abnormally low merger measures may indicate that float pressures are too heavy. Improved float settings may improve fuel efficiency. Reductions in impact damage to mowing instruments may also be observed.

In another example, abnormally high cutting power with normal propulsion, converging, conditioning, and merging power may suggest poor header height (ground strike) or worn knives. Adjustments for proper gage shoe settings, tilt and knife replacement may improve operating efficiency and reduce field damage.

In another example, normal propulsion power, normal header power, and normal cutting, converging and conditioner power with no merger power during a prescribed merging pass may assist the operator to quickly discover that the merger was not engaged. Thus, operational errors may be quickly detected thus eliminating rework and damage to hay and forage crops.

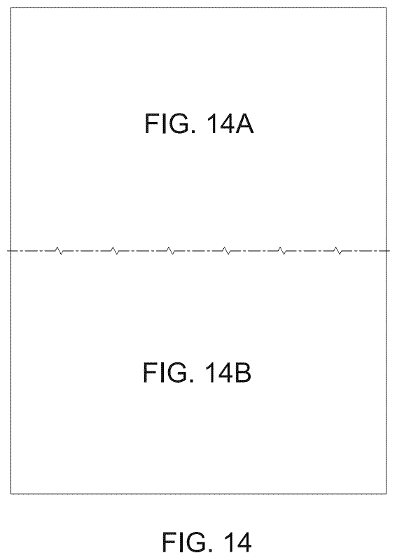

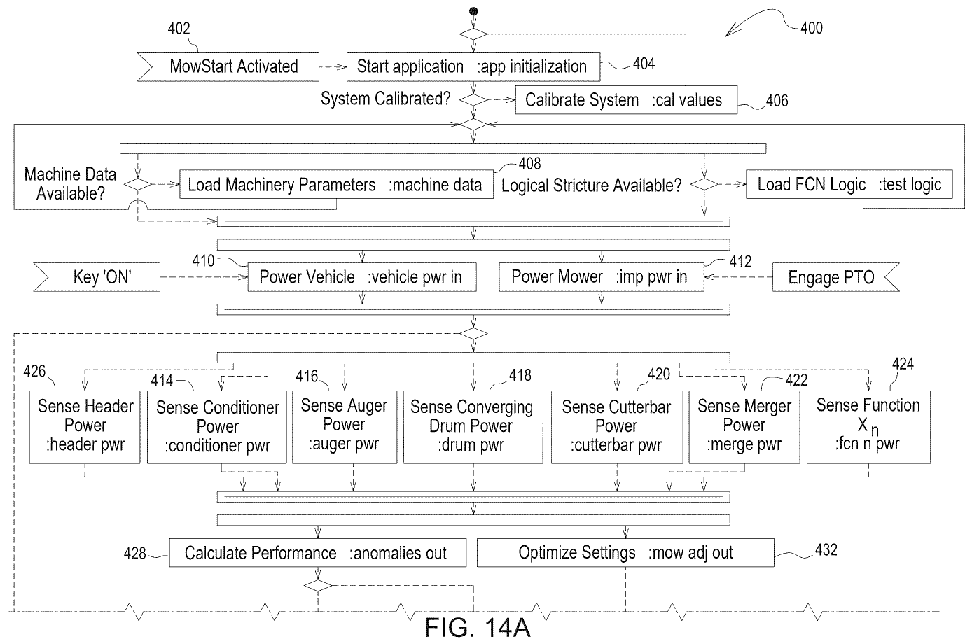

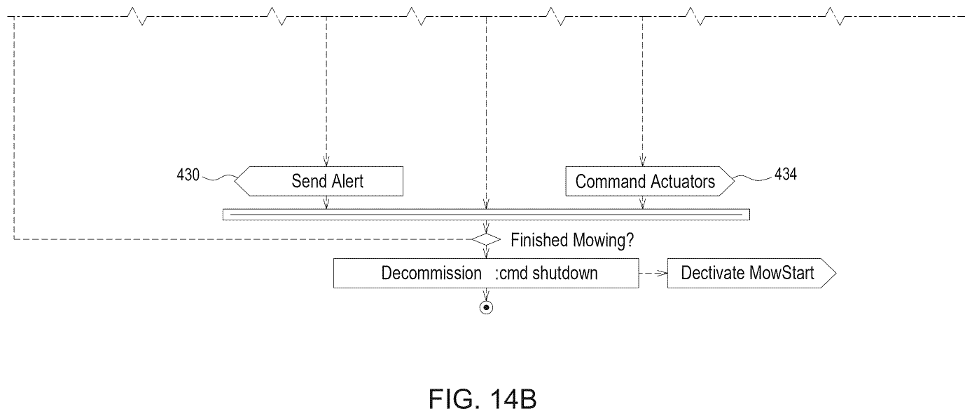

FIG. 14 is a flow chart of one embodiment of a software implementation of the processes described above. A mowing performance monitoring and management program 400 may be implemented as a part of the computer program product 316 noted above.

The program 400 may be activated at block 402 when the operator of the crop harvesting machine 10 starts up the machine, or when the program 400 is otherwise activated by a selective action by the operator. The program starts at block 404 and then may go through a calibration sequence at block 406. Various machinery parameters may be loaded at block 408. The vehicle power (such as the internal combustion engine) may be turned on at block 410 and the power may be mechanically connected to the mower header as indicated at block 412.

Then with the crop harvesting machine moving forward in an operational mode to cut the crop material, the power consumption by the drives of the various components may be monitored. The conditioner drive power consumption 232 by conditioner drive 230 may be sensed by conditioner drive power sensor 234 as indicated at block 414. The converging auger drive power consumption 216 by converging auger drive 214 may be sensed by converging auger drive power sensor 218 as indicated at block 416. The converging drum drive power consumption 224 by the converging drum drives 220 and 222 may be sensed by converging drum drive power sensors 226 and 228 as indicated at block 418. The cutting bar drive power consumption 210 by cutting bar drive 208 may be sensed by cutting bar drive power sensor 212 as indicated at block 420. The merger drive power consumption 238 by the merger drive 236 may be sensed by merger drive power sensor 240 as indicated at block 422. Power consumption by any other components may be sensed as indicated at block 424.

The controller 302 may aggregate some or all of the power consumptions of the various component drives as an aggregate header power as indicated at block 426.

Then as indicated at block 428 the controller may analyze the power consumption by the various drives of the components of the system to identify any performance anomalies within the crop harvesting implement. If an anomaly is detected the controller 302 may send an alert to the operator of the crop harvesting machine 10 as indicated at block 430.

As indicated at block 432 the controller 302 may also be configured to react to detected anomalies by adjusting a setting of one or more of the actuators of the crop harvesting machine. For example, upon detecting a potential plugging at one location within the machine the controller may command an actuator to increase of a passage width at such location to reduce or eliminate the plugging as indicated at block 434.

The system described above is configured to optimize or improve mower performance so as to reduce or eliminate performance anomalies at various functional components of the crop harvesting machine 10. Such performance anomalies may include plugging as has previously been noted, or other anomalies such clumped windrows created behind the crop harvesting machine 10. Such performance anomalies result in nutrient loss in the cut crop material and in unscheduled downtime for the operator, all at substantial cost. The occurrence of such anomalies increases with abrupt changes in crop conditions, machine operating speeds or crop processing rates. Other changes in crop conditions include downed crop, differences in yield quantity across a field, and changes in moisture content of the crop material.

To address these issues the present disclosure provides independent drive controls for the various machine functions, monitoring of the power draws at the various machine functions, and analysis of the relative power draws that leads to identification of potential plugging or other anomalies. The controller can then react to the detected problem by automatically adjusting one or more actuators to adjust various flow passages through the machine, thereby minimizing plugging and improving the quality and quantity of production by the crop harvesting machine. The controller may also react to the detected problem by adjusting one or more actuators to adjust other machine parameters, such as machine advance speed, and the operational speed of the various drives. Ideally the controller identifies and reacts to potential problems while they can still be managed by adjustment of the various function actuators and other machine parameters such as machine advance speed, and the operational speed of the various drives, so that catastrophic anomalies requiring machine shutdown may be avoided or minimized.

Thus, it is seen that the apparatus and methods of the embodiments disclosed herein readily achieve the ends and advantages mentioned as well as those inherent therein. While certain preferred embodiments have been illustrated and described for purposes of the present disclosure, numerous changes in the arrangement and construction of parts and steps may be made by those skilled in the art, which changes are encompassed within the scope and spirit of the present disclosure as defined by the appended claims.

1. A crop harvesting implement for cutting crop material, comprising:
a cutting bar including a plurality of cutters disposed along an axis which is transverse to a forward working direction of the crop harvesting implement, the cutters being configured to cut the crop material;
a cutting bar drive;
a cutting bar power sensor configured to detect one or more parameters corresponding to a power consumption by the cutting bar drive and to generate a cutting bar power signal corresponding to the power consumption by the cutting bar drive;
a crop conditioner configured to condition the cut crop material, wherein the crop conditioner is located downstream of the cutting bar with respect to the working direction;
a conditioner drive;
a conditioner power sensor configured to detect one or more parameters corresponding to a power consumption by the conditioner drive and to generate a conditioner power signal corresponding to the power consumption by the conditioner drive; and
a controller operatively associated with the cutting bar power sensor and the conditioner power sensor to receive the cutting bar power signal and the conditioner power signal, respectively, the controller being configured to command operation of at least one functional component of the crop harvesting implement at least in part in response to at least one of the power signals.

2. The crop harvesting implement of claim 1 further comprising:
a crop converger configured to move the cut crop material in a downstream direction from the plurality of cutters toward the crop conditioner;
a converger drive;
a converger power sensor configured to detect one or more parameters corresponding to a power consumption by the converger drive and to generate a converger power signal corresponding to the power consumption by the converger drive; and
wherein the controller is operatively associated with the converger power sensor to receive the converger power signal.

3. The crop harvesting implement of claim 1 further comprising:
a merger configured to move the cut crop material laterally relative to the working direction, wherein the merger is located downstream of the crop conditioner with respect to the working direction;
a merger drive;
a merger power sensor configured to detect one or more parameters corresponding to a power consumption by the merger drive and to generate a merger power signal corresponding to the power consumption by the merger drive; and
wherein the controller is operatively associated with the merger power sensor to receive the merger power signal.

4. The crop harvesting implement of claim 1 further comprising:
at least one crop condition sensor configured to detect a condition of the cut crop material and to generate a crop condition signal representative of the crop condition; and
wherein the controller is operatively associated with the at least one crop condition sensor to receive the crop condition signal, and the controller is configured to command operation of the at least one functional component of the crop harvesting implement at least in part in response to the crop condition signal.

5. The crop harvesting implement of claim 4, wherein:
the at least one crop condition sensor is selected from the group consisting of a moisture sensor, a Near Infrared sensor, a weight sensor, and a crop quality sensor.

6. The crop harvesting implement of claim 1, wherein:
the at least one functional component of the crop harvesting implement includes an actuator configured to adjust a width of a passage through which the cut crop material flows; and
the controller is configured to send a command signal to the actuator to adjust the width of the passage through which the cut crop material flows.

7. The crop harvesting implement of claim 6, wherein:
the crop conditioner includes a first conditioner roll configured for rotation about a first conditioner roll axis and a second conditioner roll configured for rotation about a second conditioner roll axis, wherein the first conditioner roll and the second conditioner roll are configured to rotate in opposite directions about each of the respective conditioner roll axes; and
the passage is a conditioning gap between the first and second conditioner rolls.

8. The crop harvesting implement of claim 6, wherein:
the passage is a forming gap between a pair of adjustably angled forming shields located downstream of the crop conditioner.

9. The crop harvesting implement of claim 6, wherein:
the passage is a flow path of cut crop material adjacent a swathgate.

10. The crop harvesting implement of claim 1, wherein:
the at least one functional component of the crop harvesting implement includes an advance drive speed control for controlling an advance speed of the crop harvesting machine.

11. The crop harvesting implement of claim 1, wherein:
the at least one functional component of the crop harvesting implement includes a cutting bar speed control for controlling a cutting speed of the cutting bar.

12. The crop harvesting implement of claim 1, wherein:
the controller is configured to compare the power consumption of a first one of the drives to the power consumption of another of the drives or to an aggregate power consumption of the crop harvesting implement to monitor for a performance anomaly in the first one of the drives or the other of the drives.

13. The crop harvesting implement of claim 12, wherein:
the controller is configured to communicate an alert to an operator of the crop harvesting implement upon detecting the performance anomaly.

14. The crop harvesting implement of claim 12, wherein:
the performance anomaly is an implement plugging by cut crop material.

15. A method of operating a crop harvesting implement to cut crop material, comprising:
providing independent drives to a plurality of functional components of the crop harvesting implement;
detecting one or more parameters corresponding to a power consumption by each of the functional components of the crop harvesting machine and generating power signals corresponding to the power consumption by each of the functional components;
receiving the power signals with an automatic controller; and
analyzing the power signals with the controller and automatically commanding operation of an actuator of the crop harvesting implement at least in part in response to at least one of the power signals.

16. The method of claim 15, wherein:
the plurality of functional components having the independent drives includes a cutting bar, a converger, a crop conditioner and a merger.

17. The method of claim 15, wherein:
the actuator commanded by the controller is configured to adjust a width of a passage through which the cut crop material flows; and
the controller sends a command signal to the actuator to adjust the width of the passage through which the cut crop material flows.

18. The method of claim 15, further comprising:
detecting one or more crop conditions of the cut crop material and generating a crop condition signal;
receiving the crop condition signal with the automatic controller; and
analyzing the crop condition signal with the controller and automatically commanding operation of the actuator of the crop harvesting implement at least in part in response to the crop condition signal.

19. The method of claim 15, wherein:
the controller compares an aggregate power consumption of the crop harvesting implement to a power consumption of one or more of the independent drives of the functional components to monitor for a performance anomaly in the one or more of the independent drives.

20. The method of claim 15, wherein:
the controller compares the power consumption of a first one of the independent drives to the power consumption of another of the independent drives to monitor for a performance anomaly in the first one of the independent drives or the other of the independent drives.
